(19) United States
(12) Patent Application Publication
(10) Pub. No.: US 2010/0104747 A1
(43) Pub. Date: Apr. 29, 2010

(54) Drop Deposition Control

(75) Inventors: Van Nguyen Truskett, Austin, TX (US); Philip D. Schumaker, Austin, TX (US); Jared L. Hodge, Austin, TX (US); Kang Luo, Austin, TX (US); Bharath Thiruvengadachari, Round Rock, TX (US)

Correspondence Address: MOLECULAR IMPRINTS, PO BOX 81536, AUSTIN, TX, 78708-1536, US

(73) Assignee: Molecular Imprints, Inc., Austin, TX (US)

(21) Appl. No.: 12/579,569

(22) Filed: Oct. 15, 2009

Related U.S. Application Data
(60) Provisional application No. 61/108,937, filed on Oct. 28, 2008.
(60) Provisional application No. 61/109,027, filed on Oct. 28, 2008.

(51) Int. Cl. B05D 7/22

(52) U.S. Cl. 427/230

(57) ABSTRACT

A dispense controller and a tool controller may aid in providing a drop pattern of fluid on a substrate. The dispense controller may provide dispense coordinates to a fluid dispense system based on the drop pattern. The tool controller may control movement of a stage and also provide synchronization pulses to the fluid dispense system. The fluid dispense system may provide the drop pattern of fluid on the substrate using the dispense coordinates and the synchronization pulses.

### CROSS-REFERENCE TO RELATED APPLICATIONS

This application claims the benefit under 35 U.S.C. §119(e)(1) of U.S. Provisional Patent Application No. 61/108,937 filed Oct. 28, 2008, and U.S. Provisional Patent Application No. 61/109,027 filed Oct. 28, 2008; both of which are hereby incorporated by reference herein in their entirety.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are hereby incorporated by reference.

An imprint lithography technique disclosed in each of the aforementioned U.S. patent publications and patent includes formation of a relief pattern in a polymerizable layer (formable liquid) and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer may then be subjected to additional processes to transfer a relief image into the substrate that corresponds to the pattern in the solidified layer.

### BRIEF DESCRIPTION OF DRAWINGS

So that the present invention may be understood in more detail, a description of embodiments of the invention is provided with reference to the embodiments illustrated in the appended drawings. It is to be noted, however, that the appended drawings illustrate only typical embodiments of the invention, and are therefore not to be considered limiting of the scope.

FIG. 1 illustrates a simplified side view of a lithographic system in accordance with one embodiment of the present invention.

FIG. 2 illustrates a simplified side view of the substrate shown in FIG. 1 having a patterned layer positioned thereon.

FIG. 3 illustrates a simplified side view of an exemplary fluid dispense system spaced apart from a substrate.

FIG. 4 illustrates a block diagram of an exemplary drop deposition control system.

FIG. 5 illustrates a flow chart of an exemplary method for controlling drop deposition.

FIG. 6 illustrates an exemplary drop pattern and associated tips of nozzle system.

FIG. 7A-7B illustrate an exemplary non-fill defect region.

FIG. 8 illustrates a flow chart of an exemplary method for minimizing non-fill defects by altering droplet placement within drop pattern.

FIGS. 9A-9C illustrate exemplary methods for minimizing localized non-fill defects.

FIG. 10 illustrates a flow diagram of an exemplary method for providing an index of visual characteristics for residual layer thickness.

FIG. 11 illustrates a simplified side view of an exemplary vision system 130 for determining visual characteristics.

FIG. 12 illustrates a flow diagram of an exemplary method for estimating residual layer thickness for a patterned layer.

### DETAILED DESCRIPTION

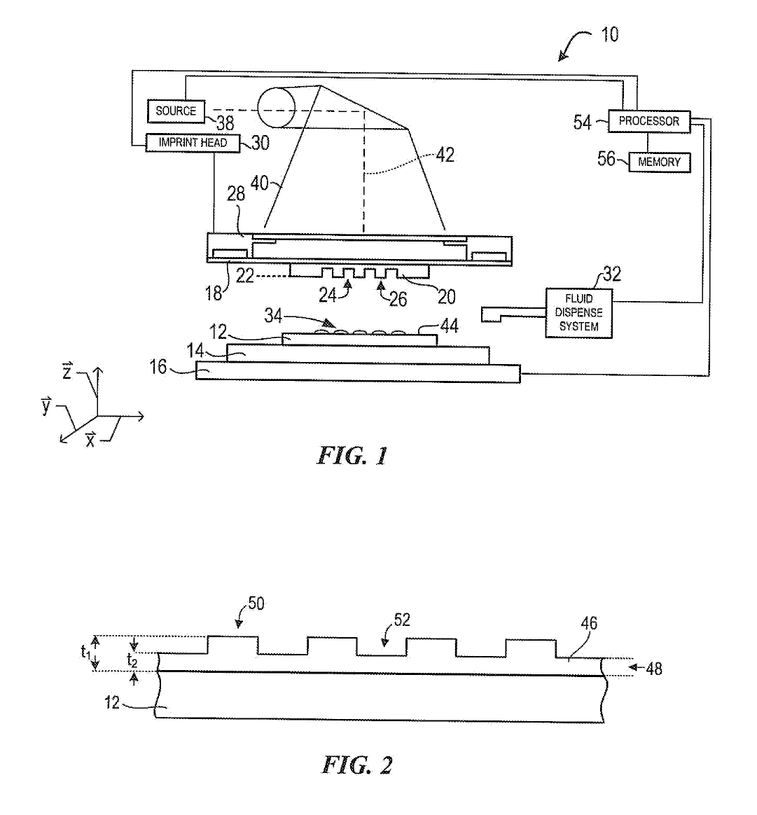

Referring to the figures, and particularly to FIG. 1, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electromagnetic, and/or the like. Exemplary chucks are described in U.S. Pat. No. 6,873,087, which is hereby incorporated by reference.

Substrate 12 and substrate chuck 14 may be further supported by stage 16. Stage 16 may provide motion about the x-, y-, and z-axes. Stage 16, substrate 12, and substrate chuck 14 may also be positioned on a base (not shown).

Spaced-apart from substrate 12 is a template 18. Template 18 generally includes a mesa 20 extending therefrom towards substrate 12, mesa 20 having a patterning surface 22 thereon. Further, mesa 20 may be referred to as mold 20. Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations. Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electromagnetic, and/or other similar chuck types. Exemplary chucks are further described in U.S. Pat. No. 6,873,087, which is hereby incorporated by reference. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit polymerizable material 34 on substrate 12. Polymerizable material 34 may be positioned upon substrate 12 using techniques such as drop dispense, spin-coating, dip coating, chemical vapor deposition (CVD), physical vapor deposition (PVD), thin film deposition, thick film deposition, and/or the like. Polymerizable material 34 may be disposed upon substrate 12 before and/or after a desired volume is defined between mold 20 and substrate 12 depending on design considerations. Polymerizable material 34 may comprise a monomer as described in U.S. Pat. No. 7,157,036 and U.S. Patent Publication No. 2005/0187339, all of which are hereby incorporated by reference.

Referring to FIGS. 1 and 2, system 10 may further comprise an energy source 38 coupled to direct energy 40 along path 42. Imprint head 30 and stage 16 may be configured to position template 18 and substrate 12 in superimposition with path 42. System 10 may be regulated by a processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by polymerizable material 34. For example, imprint head 30 may apply a force to template 18 such that mold 20 contacts polymerizable material 34. After the desired volume is filled with polymerizable material 34, source 38 produces energy 40, e.g., broadband ultraviolet radiation, causing polymerizable material 34 to solidify and/or cross-link conforming to shape of a surface 44 of substrate 12 and patterning surface 22, defining a patterned layer 46 on substrate 12. Patterned layer 46 may comprise a residual layer 48 and a plurality of features shown as protrusions 50 and recessions 52, with protrusions 50 having thickness t₁ and residual layer having a thickness t₂.

The above-mentioned system and process may be further employed in imprint lithography processes and systems referred to in U.S. Pat. No. 6,932,934, U.S. Pat. No. 7,077,992, U.S. Pat. No. 7,179,396, and U.S. Pat. No. 7,396,475, all of which are hereby incorporated by reference in their entirety.

As described above, polymerizable material 34 may be applied to the defined volume between template 18 and substrate 12 using a fluid dispense system 32. Exemplary fluid dispense systems 32 may include, but are not limited to, a printhead, a microjet tube, syringe, or similar systems that are able to eject a drop of fluid (e.g., =50 picoliters of fluid).

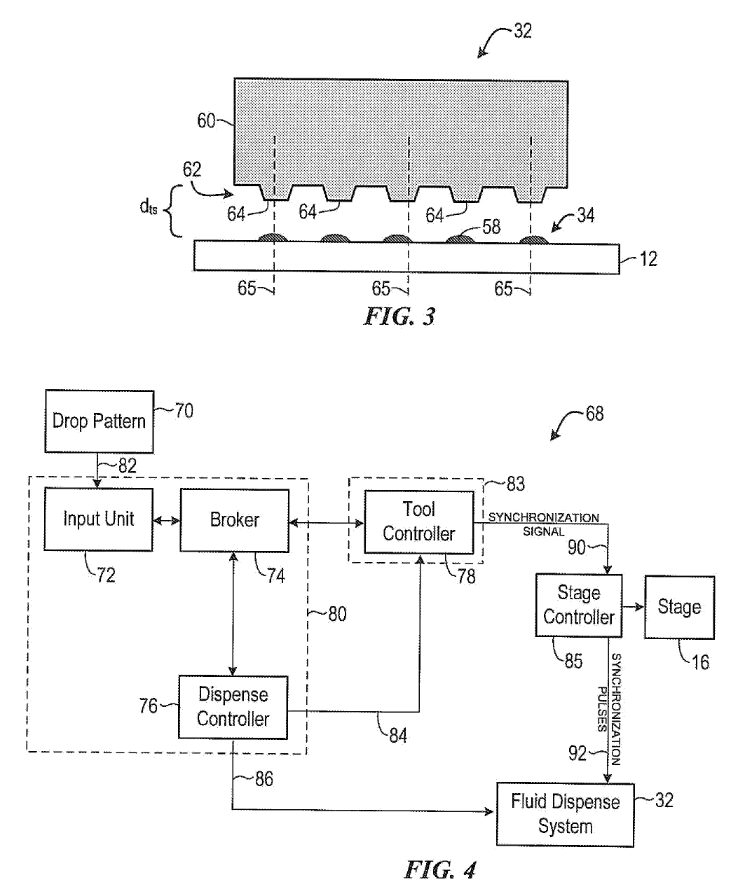

FIG. 3 illustrates an exemplary embodiment of fluid dispense system 32 providing droplets 58 on substrate 12. Although embodiments described and illustrated herein provide for the use of polymerizable material 34, it should be noted that other fluids may be used with fluid dispense system 32 in accordance with the present invention. For example, fluids may include, but are not limited to, biomaterials, solar cell materials, and/or the like.

Fluid dispense system 32 may comprise a dispense head 60 and nozzle system 62. Nozzle system 62 may comprise a single nozzle 64 or a plurality of nozzles 64 depending on design considerations. For example, FIG. 3 illustrates nozzle system 62 comprising a plurality of nozzles 64. Nozzle 64 defines a dispensing axis 65 at which polymerizable material 34 may be deposited on substrate 12. The distance dₜₛ between nozzle 64 and substrate 12 may be selected to avoid splashing, to prevent gas from being present in polymerizable material 34, and/or to provide for other similar design considerations.

### Drop Deposition System

FIG. 4 illustrates a block diagram of an exemplary drop deposition system 68. Generally, drop deposition system 68 may include systems to direct fluid dispense system 32 to deposit polymerizable material 34 on substrate 12 based on a pre-determined drop pattern 70. Drop pattern 70 may define any original pattern that may be used to apply polymerizable material 34 to the defined volume between template 18 and substrate 12 as described in relation to FIGS. 1 and 2. Drop pattern 70 may be user generated and/or software generated.

In general, system 68 may include an input unit 72 to receive drop pattern 70. Input unit 72 communicates drop pattern 70 to broker system 74 that in turn queues processes to a dispense controller 76 and a tool controller 78. Tool controller 78 may manage and control stage controller 85 to provide the location at which the drop pattern 70 may be dispensed; and dispense controller 76 may manage and control fluid dispense system 32 to provide how drop pattern 70 may be dispensed.

Input unit 72, broker system 74, and/or dispense controller 76 may be supported by one or multiple computing systems 80 able to embody and/or execute the logic of the processes described herein. For example, as illustrated in FIG. 4, input unit 72, broker system 74, and dispense controller 76 may be supported by computing system 80. Alternatively, input unit 72, broker system 74, and/or dispense controller 76 may be supported by separate computing systems 80. Generally, computing system 80 includes a processor, video display, keyboard and mouse. Exemplary computing systems 80 are well-known and commercially available from a variety of manufacturers.

Input unit 72 may be capable of receiving drop pattern 70 and providing drop pattern 70 to broker system 74. For example, drop pattern 70 may be manually generated (e.g., user generated) and/or automatically generated (e.g., software generated to input unit 72 over one or more communication links 82. Communication links 82 may be hard wired, wireless, or any other communication mechanism capable of transmitting data. Broker system 74 may be capable of receiving drop pattern 70 from input unit 72 and queuing process based on drop pattern 70 to the dispense controller 76 and the tool controller 78.

Dispense controller 76 may receive drop pattern 70 from broker system 74 and determine how to dispense the drop pattern 70 from fluid dispense system 32. For example, dispense controller 76 may determine dispense coordinates (i.e., the amount of polymerizable fluid 34 to be dispense at each X and Y coordinate location based on drop pattern 70. Using this information, dispense controller 76 may further determine the number of times the fluid dispense system 32 may pass over substrate 12 (i.e., a pass-over value). Additionally, dispense controller 76 may determine a nozzle value (e.g., the number of nozzles 64 that may be used, nozzles 64 that may be utilized, location of nozzles 64, dispense timing of nozzles 64, and/or the like). Dispense controller 76 may provide determinations on how to dispense drop pattern 70 to fluid dispense system 32 by communication link 86. Communication link 86 may be hard wired, wireless, or any other communication mechanism capable of transmitting data.

In an exemplary embodiment, dispense controller 76 may determine the magnitude and/or direction of movement of stage 16 to place substrate 12 in alignment for the dispensing of drop pattern 70 by fluid dispense system 32. Additionally, dispense controller 76 may determine relative position of stage 16. For example, dispense controller 76 may determine a start location and a stop location. The relative position, magnitude and direction of this movement is hereinafter referred to as dispense vector. Dispense controller 76 may provide the dispense vector to tool controller 78 by communication link 84. Communication link 84 may be hard wired, wireless, or any other communication mechanism capable of transmitting data. Alternatively, dispense controller 76 may provide dispense vector to tool controller 78 through broker 74.

Tool controller 78 may be supported by one or multiple computing systems 83 able to embody and/or execute the logic of the processes described herein. Generally, computing system includes a processor and memory. For example, as illustrated in FIG. 4, computing system 83 may support tool controller 78. Alternatively, processor 54 and memory 56 (shown in FIG. 1) may be capable of supporting tool controller 78.

Tool controller 78 generally may manage and/or substantially control motion of stage 16 by communication with stage controller 85. For example, tool controller 78 may use the dispense vector to determine and/or control movement of stage 16 prior to and during dispensing of polymerizable fluid 34. In one embodiment, tool controller 78 may command movement of stage 16 and may require stage controller 85 to provide timing of dispensing based on dispense vectors.

Fluid dispense system 32 may receive a determination on how to dispense drop pattern 70 from dispense controller 74 and/or a synchronization request 90 from tool controller 78 to provide dispensing of polymerizable material 34 on substrate 12. For example, dispense controller 74 may command the dispense system 32 to actuate the dispense head 60 and provide polymerizable material 34 on substrate 12 upon receiving each pulse in a series of synchronization pulses 92 from the stage controller 85. Synchronization pulses 92 may be initiated by synchronization request 90 from tool controller 78.

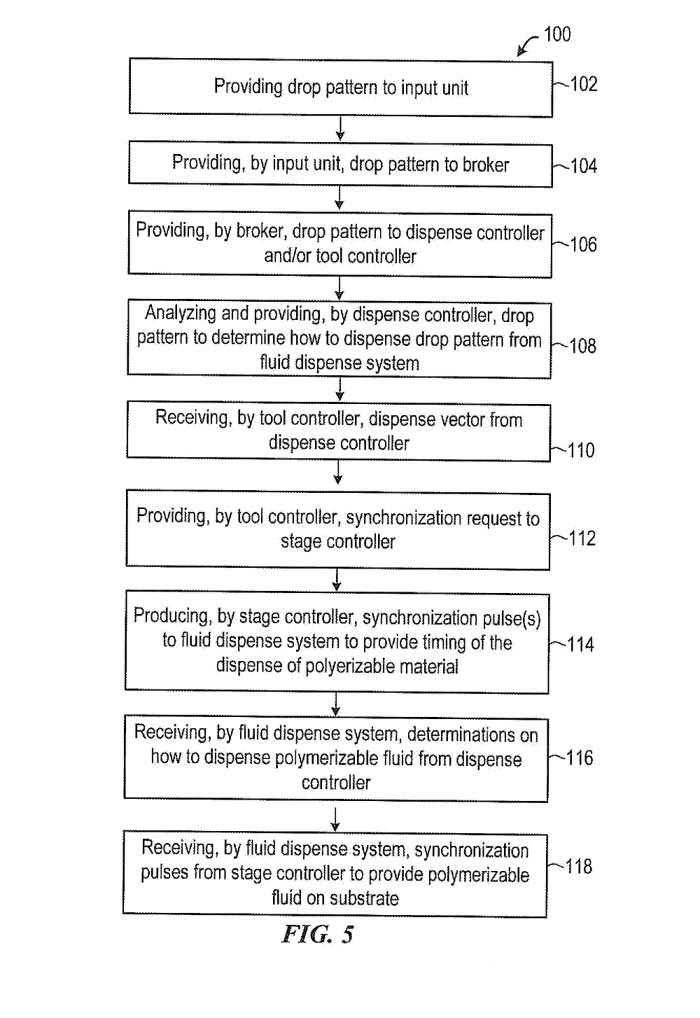

FIG. 5 illustrates an exemplary method 100 for providing drop pattern 70 of polymerizable material 34 on substrate 12. In a step 102, one or more drop patterns 70 may be provided to input unit 72 by communication link 82. In a step 104, input unit 72 may provide drop pattern 70 to broker 74. In a step 106, broker 74 may provide drop pattern 70 to dispense controller 76 and/or tool controller 78. In a step 108, dispense controller 76 may analyze drop pattern 70 and determine how to dispense drop pattern 70 from fluid dispense system 32. For example, dispense controller 76 may analyze drop pattern 70 to provide dispense vector for movement of stage to place substrate 12 in alignment with fluid dispense system 32 prior to and during dispensing of polymerizable material 34. In a step 110, tool controller 78 may receive dispense vector from dispense controller. In step 112, tool controller may provide synchronization request 90 to stage controller 85. In a step 114, stage controller 85 may provide one or more synchronization pulses 92 based on the synchronization request 90 to fluid dispense system 32. The synchronization pulses 92 may provide amount, location, and timing for dispensing of polymerizable fluid 34 on substrate 12. In step 116, fluid dispense system 32 may receive determinations on how to dispense polymerizable fluid 34 from dispense controller 76. For example, dispense controller 76 may provide magnitude and/or direction of movement of stage 16 to place substrate 12 in alignment for the dispensing of drop pattern 70 by fluid dispense system 32. In a step 118, fluid dispense system 32 may receive synchronization pulses 92 from stage controller 85 to provide polymerizable fluid 34 on substrate 12. It should be noted that multiple steps in the process may be performed simultaneously.

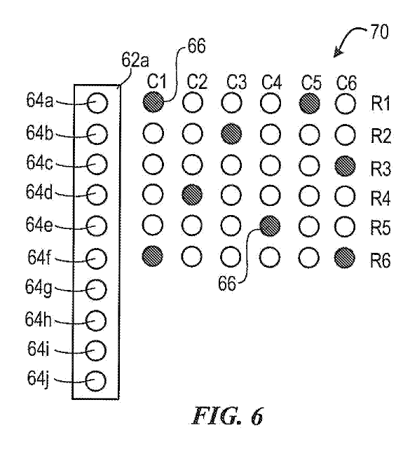

As described above and illustrated in FIG. 3, fluid dispense system 32 may be used to deposit polymerizable material 34 on substrate 12. Generally, polymerizable material 34 propagating through dispense head 60 egresses from at least one nozzle 64 of dispense system 62. Polymerizable material 34 may be provided in the form of a droplet 66 in drop pattern 70 as illustrated in FIG. 6. Generation of drop pattern 70 may be manually generated or automatically generated. Drop patterns 70 and/or substrate 12 may need adjustments to provide for minimal defects.

### Adjustments to Drop Pattern to Minimize Non-Fill Defects

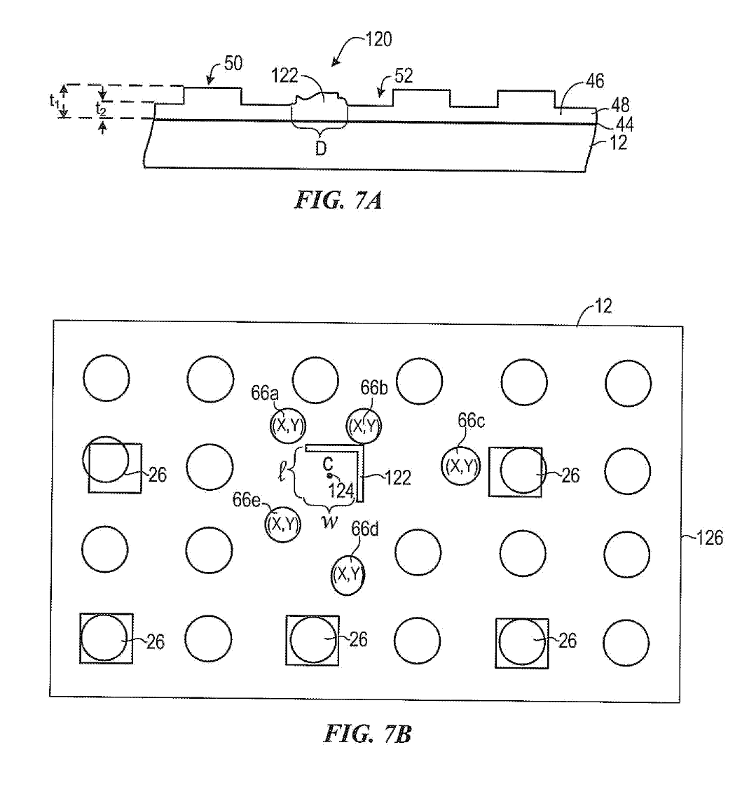

Referring to FIGS. 7A and 7B, in some circumstances, patterned layer 46 may be formed with non-fill defects 120 resulting in a misshapen or missing targeted feature 122. Non-fill defects 120 may result from a variety of causes. For example, a malfunctioning nozzle 64 of dispense system 62 (shown in FIG. 3) may fail to provide droplets 66 of polymerizable material 34 leading to non-fill defect 120. Non-fill defects 120 may also be provided by misplacement of droplets 66 within drop pattern 70. For example, as illustrated in FIGS. 7A and 7B, misplacement of droplets 66a-e may provide non-fill defect 120 resulting in misshapen targeted feature 122. Misplacement may be result of variances in the surface 44 of substrate 12.

Drop pattern 70 and/or droplets 66 may be adjusted to compensate for misplacement of droplets 66 resulting in non-fill defects 120. For example, positional coordinates of the misplaced droplet 66 may be determined. These positional coordinates may be used to alter the drop pattern 70 such that droplets 66 provide the targeted feature 50 and/or 52. Alternatively, using the positional coordinates, additional droplets 66 may be localized to missing targeted feature 122.

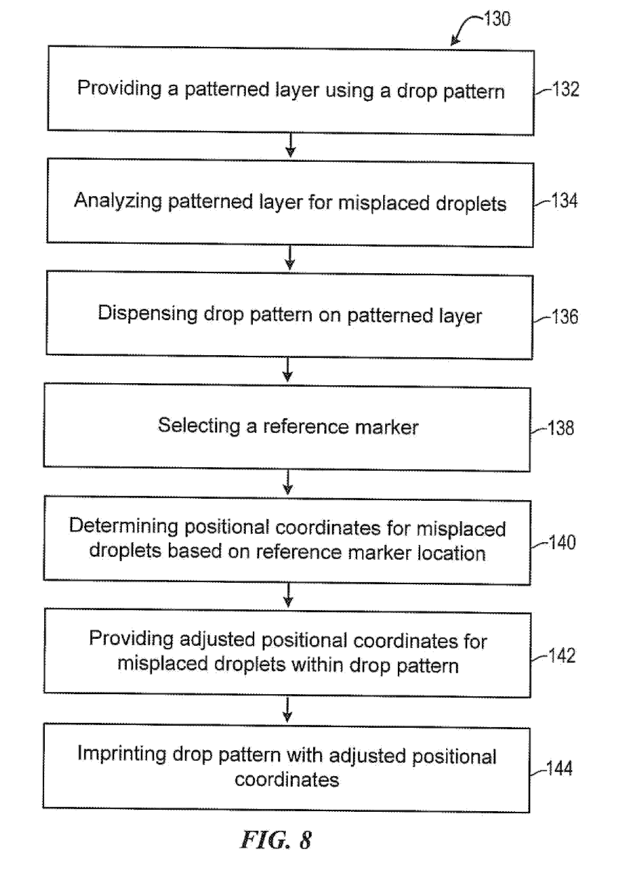

FIG. 8 illustrates a flow chart of a method 130 for minimizing non-fill defects 120 by altering placement of droplet 66 within drop pattern 70. In a step 132, a first set of droplets 66 may be patterned using drop pattern 70 and methods as described in relation to FIGS. 1 and 2. In a step 134, patterned layer 46 provided by the first set of droplets 66 may be analyzed for non-fill defects 120 and/or misplaced droplets 66. In a step 136, a second set of droplets 66 of fluid (e.g., polymerizable fluid 34) may be dispense in drop pattern 70 on patterned layer 46. In a step 138, a reference marker 124 may be selected by which to base the positional coordinates (X, Y) of misplaced droplets 66. Reference markers 124 may be targeted feature 122, alignment marks, features 50 and/or 52, and/or the edge 126 of substrate 12. For example, in FIG. 7B, reference marker 124 may be the center C of targeted feature 122.

In a step 140, positional coordinates (X. Y) of misplaced droplets 66 may be determined. For example, in FIG. 7B, positional coordinates (X. Y) of droplets 66a-e may be determined based on center C of targeted feature 122. In a step 142, positional coordinates (X, Y) may be used to adjust X and Y drop locations within the drop pattern 70. For example, positional coordinates (X, Y) in drop pattern 70 may be adjusted to (X_{A}, Y_{A}) wherein (X_{A}, Y_{A}) may be located at a shorter distance to center C of targeted feature 122 than positional coordinates (X, Y). Alternatively, positional coordinates (X, Y) may be used to account for additional droplets 66 in drop pattern 70 compensating for non-fill defects 120. For example, an additional droplet 66 may be positioned near center C of targeted feature 122 based on the layout of droplets 66a-e around center C of targeted feature 122 illustrated in FIG. 7B. Generally, alterations of positional layout and additional placement of droplets 66 may be determined so as to minimize substantial alterations in thickness t₂ of residual layer 48 as shown in FIG. 7A.

In a step 144, the second set of droplets 66 may be patterned using adjusted positional coordinates (X_{A}, Y_{A}). Alternatively, a third set of droplets 66 may be patterned using adjusted positional coordinates (X_{A}, Y_{A}). It should be noted that steps 134-142 may be repeated as needed.

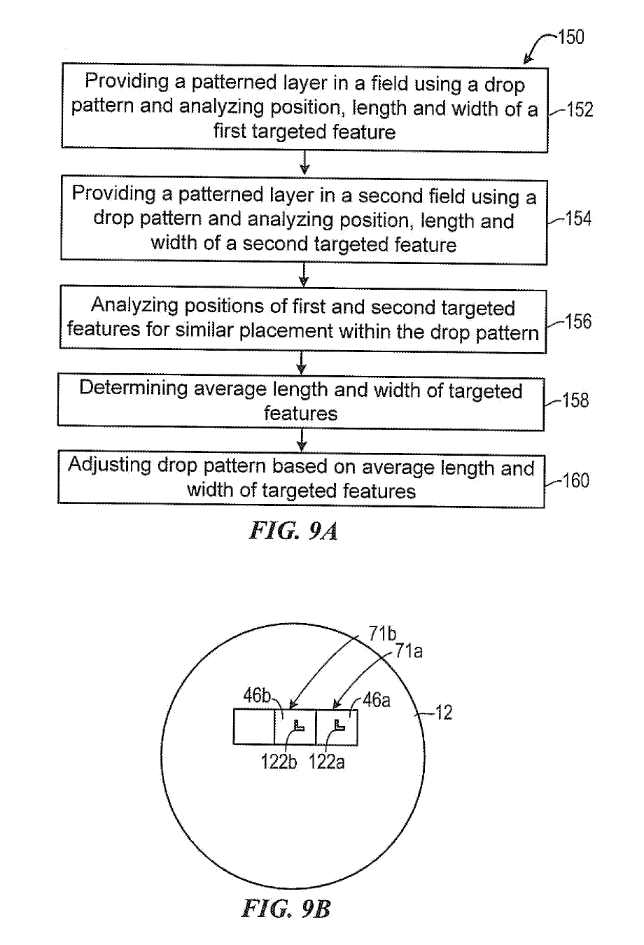

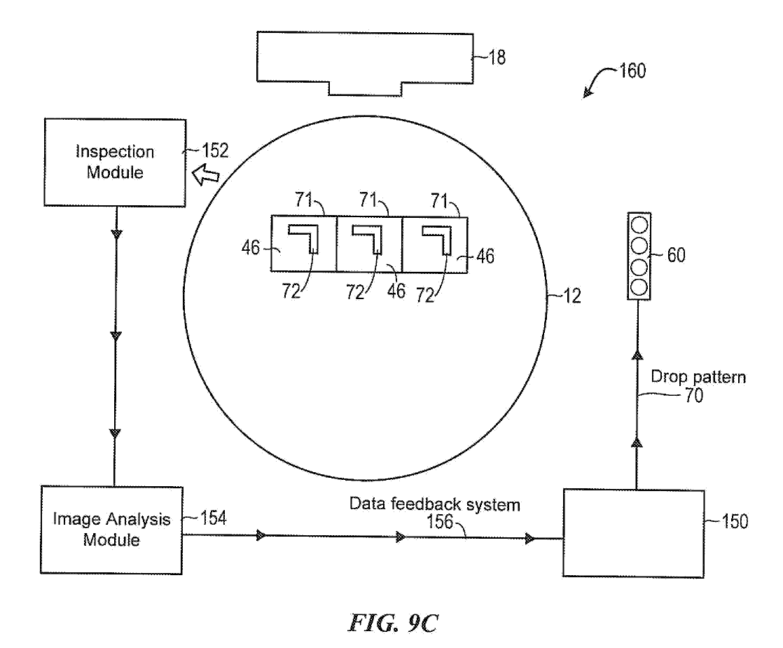

FIGS. 9A and 9B illustrates an exemplary method 150 for minimizing localized non-fill defects 120 by averaging misplacement over multiple fields of a substrate 12 (e.g., in a step and repeat process). In a step 152, patterned layer 46a may be formed in a field 71a on substrate 12 and analyzed to determine position (X, Y), length l and width w of targeted feature 122a that may result from non-fill defects 120 and/or misplaced droplets 66 (as shown in FIG. 7A). In a step 154, a second patterned layer 46b may be formed in a field 71b on substrate 12 and analyzed to determine position (X, Y), length l and width w of targeted feature 122b that may result from non-fill defects 120 and/or misplaced droplets 66 (as shown in FIG. 7A). In a step 156, positions of targeted feature 122a and 122b may be analyzed for similar placement within drop pattern 70. In a step 158, average length l and width w of targeted features 122a and 122b may be determined. In a step 110, average length l and width w of the targeted features 122a and 122b may be used to adjust drop pattern 70 for targeted features 122a and 122b having similar positions within the drop pattern 70. For example, at the position of the targeted features 122a and/or 122b in drop pattern 70, additional droplets 66 may be added based on the average length l and width w either directly to fluid positioned on substrate 12 or by modification of drop pattern (e.g., manually and/or automatically generated). As size of the targeted feature 122a and/or 122b may be substantially accurately estimated, an appropriate amount of droplet 66 may be added. It should be noted that other identifying characteristics of targeted features 122a and/or 122b (e.g., positional characteristics) may be used and averaged over multiple fields (e.g., fields 71a and/or 71b) to provide for adjustments to drop pattern 70.

FIG. 9C illustrates a block diagram of an exemplary process 160 for minimizing localized non-fill defects 120 by averaging misplacement over multiple fields 71. Generally, an initial drop pattern 70 may be generated by a drop pattern generation module 150. Fields 71 of substrate 12 may be dispensed by dispense head 60 according to drop pattern 70 and imprinted with template 18 to form patterned layer 46 as related to methods described in relation to FIGS. 1 and 2. Substrate 12 may be transferred to a microscope/defect inspection module 152. Images may be captured by the microscope/defect inspection module 152 and transferred to an image analysis module 154. Drop pattern misplacement data and non-fill defect geometry information may then be extracted by the image analysis module 154. This data may be sent to the drop pattern generation module 150 through a data feedback system 156. Drop pattern generation module 150 may then provide a new drop pattern 70. This process may be repeated until a pre-determined threshold may be achieved.

### Adjustment of Residual Layer

As previously described in relation to FIGS. 1 and 2, patterned layer 46 may comprise residual layer 48 and features 50 and 52, with protrusions 50 having thickness t₁ and residual layer having a thickness t₂. Currently within the art, measurements of residual layer thickness t₂ may be made through the use of a spectroscopic reflectrometer system. For example, measurements of residual layer thickness t₂ may be through the use of VUV-7000 manufactured by Metrosol in Austin, Tex. In certain situations, however, access to spectroscopic reflectrometer systems may be limited.

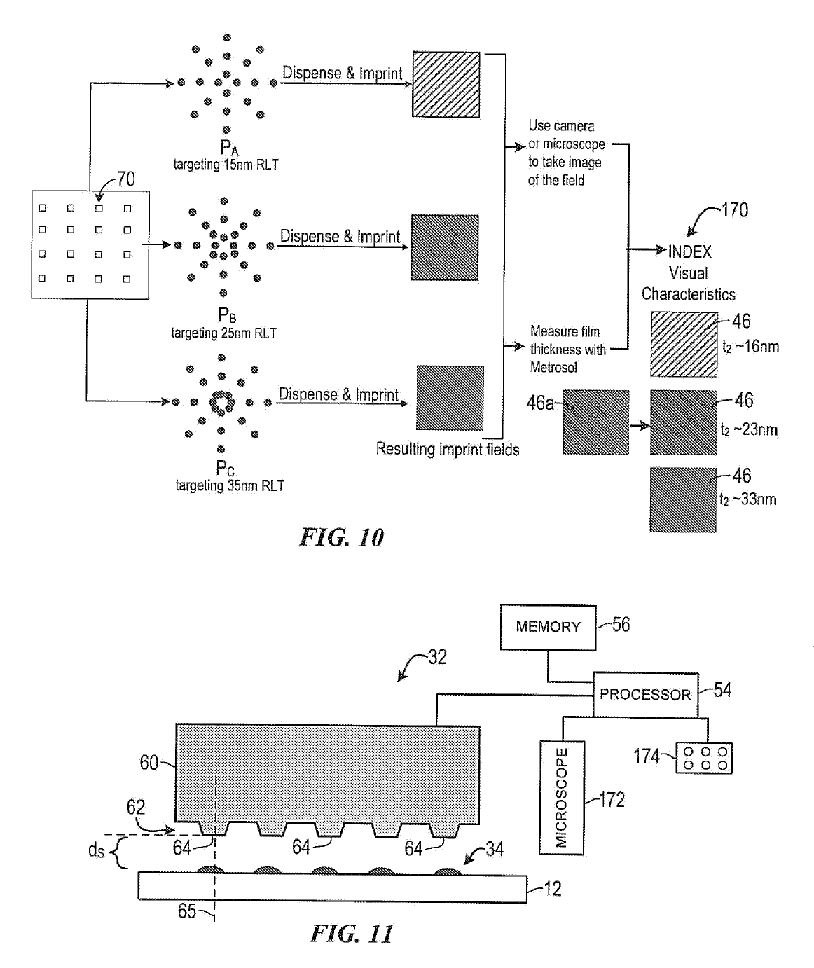

Referring to FIGS. 2, 10 and 11, index 170 may provide an approximation of the residual layer thickness t₂ (also referred to herein as RLT) of patterned layer 46. Index 170 may contain values of RLT and visual characteristics (e.g., color) of different patterns P. An approximation of the RLT for an unmeasured residual layer 48 may be provided by comparing visual characteristics of the unmeasured residual layer 48 with the known visual characteristics associated with RLT in the index 170.

To determine RLT for index 170, template 18 may be imprinted using drop patterns 70 with different patterns P. Each pattern P may provide for a different RLT. For example, in FIG. 8 there are three different drop patterns P_{A-C} represented. It should be noted that index 170 may not be limited to the three drop patterns P_{A-C} illustrated in FIG. 8 and may apply to any original pattern. Once imprinted, measured residual layer thickness t_{2M} may be provided by a spectroscopic reflectrometer system. For example, measured P_{A} residual layer thickness generally provides a residual layer thickness t_{2M} of 15 nm, measured P_{B} generally provides a residual layer thickness t_{2M} of 25 nm, and measured P_{C} generally provides a residual layer thickness t_{2M} of 35 nm.

FIG. 11 illustrates an exemplary vision system 130 for determining visual characteristics. Visual characteristics (e.g., color) may be determined through the use of a vision system 172. Vision system 172 may include a microscope (e.g. optical microscope), a camera, and/or the like. For example, FIG. 11 illustrates a microscope in vision system 172. Vision system 172 may provide one or more images 174 of substrate 12. Vision system 172 may be regulated by processor 54, and further may operate on a computer readable program stored in memory 56. Processor 54 may evaluate image 174 provided by vision system 172 of substrate 12. Alternatively, evaluation of image 174 may be manually provided by a user. Vision system 172 may provide feedback to control dispensing of polymerizable material 34 from fluid dispense system 32 (FIG. 1).

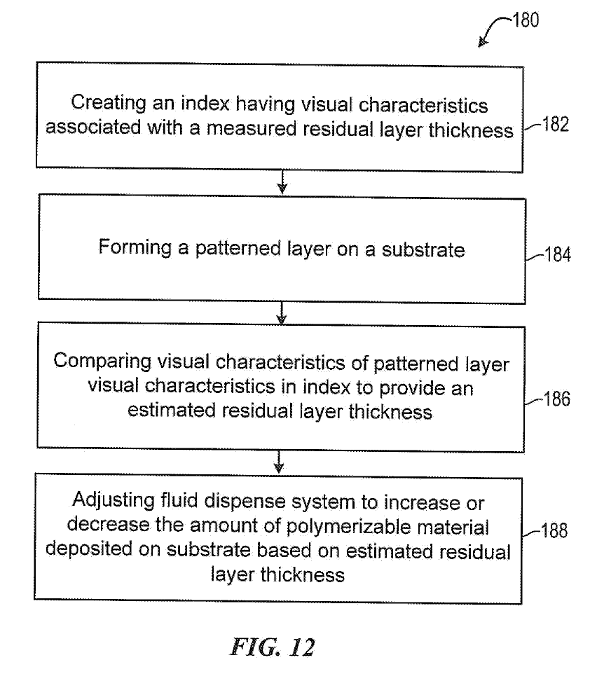

FIG. 12 illustrates a flow chart of an exemplary method 180 for estimating RLT for patterned layer 46 using visual characteristics. In a step 182, index 170 may be created having visual characteristics associated with values of measured residual layer thickness t_{2M}. For example, index 170 may comprise a series of different measured residual layer thicknesses t_{2M} (e.g., 5 nm to 200 nm in increments of 15 nm). Visual characteristics (e.g., color) may be associated with the measured residual layer thicknesses t_{2M}. In a step 184, patterned layer 46 may be formed on substrate 12. In a step 186, visual characteristics of patterned layer 46 may be compared to visual characteristics in index 170 having measured residual layer thicknesses t_{2M}. For example, visual characteristics of patterned layer 46 may be compared to visual characteristics in index 170 to provide an estimated residual layer thickness t₂ for patterned layer 46. In a step 188, fluid dispense system 32 may be adjusted to increase or decrease the amount of polymerizable material 34 deposited on substrate 12 based on estimated residual thickness t₂.

What is claimed is:

1. A method for providing a drop pattern of fluid on a substrate, comprising:
determining, by a dispense controller, dispense coordinates based on the drop pattern and providing the dispense coordinates to a fluid dispense system, the dispense coordinates providing an amount of the fluid to be dispensed by a fluid dispense system at coordinate locations on the substrate;
determining, by a tool controller, a synchronization request and movement commands for a stage controller based on the drop pattern, the stage controller adjusting movement of a stage based on the movement commands and providing at least one synchronization pulse to the fluid dispense system based on the synchronization request; and,
dispensing, by the fluid dispense system, the drop pattern of the fluid on the substrate using the synchronization pulses and dispense coordinates.

2. The method of claim 1, further comprising providing the drop pattern to a broker system for communication of the drop pattern to the dispense controller and the tool controller.

3. The method of claim 2, wherein the drop pattern is provided to the broker system through an input unit.

4. The method of claim 3, wherein the drop pattern is manually generated.

5. The method of claim 3, wherein the drop pattern is automatically generated.

6. The method of claim 1, further comprising determining, by the dispense controller dispense vector movement based on the drop pattern and providing the dispense vector movement to the tool controller, the tool controller using the dispense vector movement to determine the movement commands.

7. The method of claim 6, wherein the dispense vector movement is provided to the tool controller through a broker system.

8. The method of claim 1, wherein the fluid is polymerizable material.

9. The method of claim 1, wherein the fluid is selected from the group consisting of biomaterial, optically active liquid, electrically active liquid, or photovoltaic material.

10. The method of claim 1, further comprising determining, by the dispense controller, a pass-over value based on the drop pattern and providing the pass-over value to the fluid dispense system, the fluid dispense system using the pass-over value to dispense the drop pattern of the fluid on the substrate.

11. The method of claim 1, further comprising determining, by the dispense controller, a nozzle value based on the drop pattern and providing the nozzle value to the fluid dispense system, the fluid dispense system using the nozzle value to dispense the drop pattern of the fluid on the substrate.

12. The method of claim 11, wherein the nozzle value indicates a number of nozzles, location of the nozzles, and dispense timing of the nozzles.

13. The method of claim 1, further comprising solidifying the fluid to form a patterned layer; and, estimating residual layer thickness for patterned layer using visual characteristics.

14. The method of claim 1, wherein the drop pattern is an original pattern used to apply polymerizable material in a defined volume between an imprint lithography template and the substrate.

15. The method of claim 1, wherein the input unit, broker system and dispense controller comprise a single computing system.

16. The method of claim 1, wherein the input unit, broker system and dispense controller comprise multiple computing systems.

17. The method of claim 1, wherein dispense coordinates include X and Y coordinate locations.

18. The method of claim 1, wherein the fluid dispense system includes a dispense head with a nozzle system, the nozzle system having at least one nozzle with a dispensing axis for dispensing fluid on the substrate.

19. A method for providing a drop pattern of fluid on a substrate, comprising:
determining, by a dispense controller, dispense coordinates, pass-over value, and nozzle value based on the drop pattern and providing the dispense coordinates, pass-over value and nozzle value to a fluid dispense system;
controlling, by a tool controller, a stage controller based on the drop pattern, the stage controller commanding movement of a stage and providing synchronization pulses to the fluid dispense system; and,
dispensing, by the fluid dispense system, the drop pattern of fluid on the substrate using the dispense coordinates, pass-over value, nozzle value, and synchronization pulses.

20. A method for providing a drop pattern of fluid on a substrate, comprising:
generating the drop pattern and providing the drop pattern to a broker system;
distributing, by the broker system, the drop pattern to a dispense controller and a tool controller;
determining, by the dispense controller, dispense coordinates of the drop pattern and providing the dispense coordinates to a fluid dispense system;
determining, by the dispense controller, dispense vector movement and providing the dispense vector movement to the tool controller;
controlling, by the tool controller, a stage controller based on the drop pattern and the dispense vector movements, the stage controller adjusting movement of a stage for dispensing of fluid on the substrate;
providing, by the tool controller, a synchronization request to the stage controller, the stage controller providing one or more synchronization pulses to the fluid dispense system based on the synchronization request, the synchronization pulses providing timing of dispense of fluid on the substrate; and,
dispensing, by the fluid dispense system, the drop pattern of fluid on the substrate based on the dispense coordinates and the synchronization pulses.
